(19) United States
(12) Patent Application Publication
(10) Pub. No.: US 2014/0026366 A1
(43) Pub. Date: Jan. 30, 2014

(54) ROTARY SHAFT DEVICE

(71) Applicant: AN SZU HSU, NEW TAIPEI CITY (TW)

(72) Inventor: AN SZU HSU, NEW TAIPEI CITY (TW)

(73) Assignee: FIRST DOME CORPORATION, NEW TAIPEI CITY (TW)

(21) Appl. No.: 13/561,187

(22) Filed: Jul. 30, 2012

(51) Int. Cl. F16C 11/04

(52) U.S. Cl. 16/337

(57) ABSTRACT

A simplified rotary shaft device with locating effect. The rotary shaft device includes a shaft body and a carrier body pivotally connected with the shaft body and an elastic member disposed on the carrier body. The carrier body has at least one main assembling section for mounting the elastic member on the carrier body with the elastic member normally contacting or interfering with the shaft body to locate the shaft body. The rotary shaft device is able to overcome the problems of the conventional locating assembly that the elastic deformation is small, the components are likely to wear and it is troublesome and time-consuming to assemble the components.

### BACKGROUND OF THE INVENTION

1. Field of the Invention

The present invention relates generally to a rotary shaft device applied to an electronic device, and more particularly to an assembly of a rotary shaft and an elastic member. In operation, the elastic member provides a reliable locating effect for the rotary shaft.

2. Description of the Related Art

There are various electronic devices provided with covers, display screens or viewers, such as cellular phones, notebooks, PDA, digital imagers and electronic books. The covers, display screens or viewers are freely reciprocally rotatably mounted on the electronic devices via pivot pins or rotary shafts, whereby the covers, display screens or viewers can be opened or closed under external force. For example, conventional skill discloses a rotary shaft structure, another conventional skill discloses a pivot pin locating assembly, and another conventional skill further discloses a pivot pin structure. These Patents provide several typical embodiments of pivot pin or rotary shaft assemblies.

The conventional pivot pin or rotary shaft assembly generally includes multiple perforated gaskets, frictional plates and elastic members assembled on the rotary shaft. Two ends of the rotary shaft are retained by retainer members to prevent the rotary shaft assembly from axially displacing. Accordingly, the rotary shaft assembly forms an axially tightened rotary shaft structure. There are also various conventional pivot pin or rotary shaft structures in which the rotary shaft is located once rotated. For example, conventional skill discloses a multi-stop rotary shaft structure and another conventional skill discloses a pivot pin structure with protrusions for providing torque.

As to operation, movement and structural design, the conventional rotary shaft assembly employs multiple gaskets, frictional plates and elastic members or multiple relevant components formed with coplanar insertion structures such as locating protrusions/dents or recessed/raised locating sections for achieving locating effect when the protrusions are rotated to the positions of the dents. In the case that these components are applied to an electronic product, after a period of operation, the coplanar locating protrusions/dents or recessed/raised locating sections are likely to wear due to rigid contact. This will deteriorate the locating effect.

As known by those skilled in this field, the conventional rotary shaft assembly employs multiple gaskets and frictional plates and cooperative elastic rings or springs for storing and releasing energy so as to provide locating effect for the rotary shaft or the pivot pin. Such structure is relatively complicated in structural design and assembling process. Moreover, the assembling/arrangement length in the axial direction is elongated. This affects and limits the arrangement space of the rotary shaft and the electronic device.

Another problem in the conventional rotary shaft and locating assembly is that the gaskets are tightened by means of wrenching the nut to a certain extent so as to adjust the elastic clamping effect or frictional resistance. In the case that the gaskets are not sufficiently tightened, the rotary shaft (the cover or the display screen) cannot be optimally located. On the contrary, in the case that the gaskets are over-tightened, the gaskets are likely to be over-stressed and permanently deformed. In this case, after a period of use, the components of the rotary shaft assembly are very likely to wear to cause unstable operation or loosening of the rotary shaft. This is because the elastic deformation of the gaskets and the frictional plates is too small.

Therefore, it is quite troublesome and difficult for an assembling worker to wrench the nut for tightening and adjusting the gaskets so as to achieve an optimal elastic clamping effect or frictional resistance. In practice, this often leads to deformation and damage of the gaskets. As a result, the ratio of defective products is increased. This is not what we expect.

According to the aforesaid, it is known that the structural design of the rotary shaft, the locating assembly and the relevant components of the conventional device has some shortcomings that need to be overcome. It is therefore tried by the applicant to provide a rotary shaft device to eliminate the problems existing in the conventional device. In practice, the rotary shaft device of the present invention can solve the above problems existing in the conventional device that the gaskets of the conventional device are likely to over-stressed and deformed and damaged and the components are likely to wear after a period of use and are troublesome to assemble. Without increasing the difficulty in assembling process, the rotary shaft of the present invention is prevented from axially displacing or loosening. Also, the rotary shaft device of the present invention is structurally different from the conventional device and has larger elastic deformation. Therefore, it is unnecessary for a worker to wrench the nut for tightening the gaskets and adjusting the frictional resistance. Accordingly, the problems of over-stressing and permanent deformation and wear of the gaskets can be eliminated and an optimal locating effect can be easily achieved.

### SUMMARY OF THE INVENTION

It is therefore a primary object of the present invention to provide a simplified rotary shaft device with locating effect. The rotary shaft device includes a shaft body and a reciprocally movable elastic member assembled with the shaft body. The elastic member normally contacts or interferes with the shaft body to locate the shaft body. The rotary shaft device is able to overcome the problems of the conventional locating assembly that the elastic deformation is small, the components are likely to wear and it is troublesome and time-consuming to assemble the components.

To achieve the above and other objects, the rotary shaft device of the present invention further includes a carrier body. The elastic member is disposed on the carrier body. The carrier body has at least one main assembling section for mounting the elastic member on the carrier body with the elastic member normally contacting or interfering with the shaft body.

In the above rotary shaft device, the elastic member has a first end, a second end and a bridge section connected between the first and second end. The bridge section has an arched form. When the elastic member interferes with the shaft body, the bridge section provides a deformation range, permitting the elastic member to elastically deform to a larger extent.

In the above rotary shaft device, the first end of the elastic member is formed with a main restraint section in the form of a slot for receiving therein a main assembling section of the carrier body. The main assembling section is movable within the main restraint section. The second end of the elastic member is formed with a subsidiary restraint section corresponding to a subsidiary assembling section of the carrier body. The subsidiary restraint section is pivotally connected with the subsidiary assembling section of the carrier body. When the shaft body or the carrier body is rotated, the elastic member is forcedly reciprocally moved and deformed to store energy or release energy.

The present invention can be best understood through the following description and accompanying drawings, wherein:

### BRIEF DESCRIPTION OF THE DRAWINGS

FIG. 1 is a perspective assembled view of the present invention, showing the assembly of the shaft body, the carrier body and the elastic member;

FIG. 2 is a perspective exploded view of the present invention according to FIG. 1;

FIG. 3 is a sectional assembled view of the present invention according to FIG. 1, showing the assembly of the shaft body, the carrier body and the elastic member;

FIG. 4 is a plane view of the present invention according to FIG. 3, showing that the first end of the elastic member interferes with the restriction section of the shaft body;

FIG. 5 is a sectional assembled view of the present invention according to FIG. 3, showing that after the elastic member is driven by the carrier body to rotate, the first end of the elastic member interferes with the base section of the shaft body; and

FIG. 6 is a plane view of the present invention according to FIG. 5, showing that the first end of the elastic member interferes with the base section of the shaft body.

### DETAILED DESCRIPTION OF THE PREFERRED EMBODIMENTS

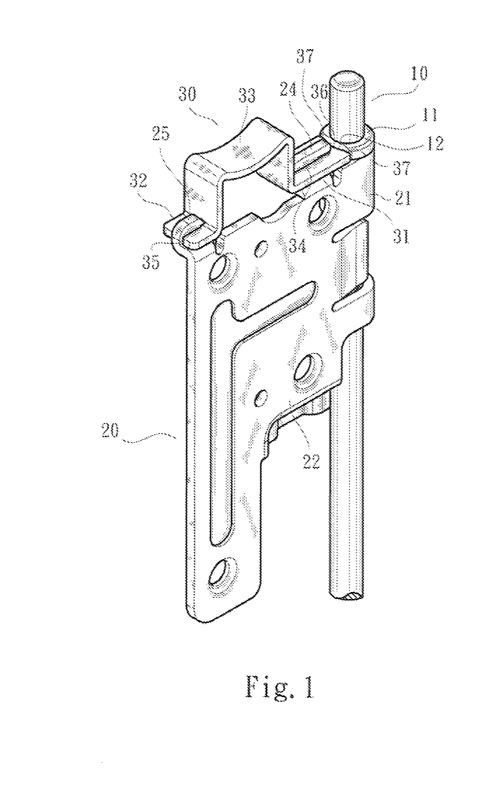

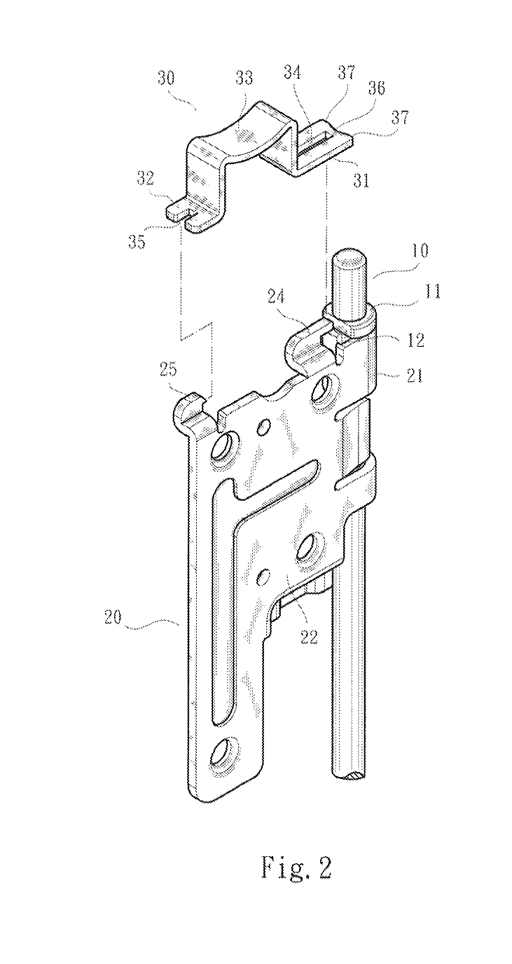

Please refer to FIGS. 1, 2 and 3. The rotary shaft device of the present invention includes a shaft body 10 and a carrier body 20 pivotally connected with the shaft body 10. The shaft body 10 has the form of a cylindrical body and can be mounted on an electronic device (not shown). The electronic device includes a device body module and a movable module (such as a cover or a display screen). To speak more specifically, the shaft body 10 and the carrier body 20 are respectively mounted on the device body module and the movable module of the electronic device. When a user rotates and opens the movable module from the device body module or closes the movable module onto the device body module, the movable module of the electronic device will drive the carrier body 20 (or the shaft body 10) to relatively rotate.

Referring to FIGS. 1, 2 and 3, the rotary shaft device further includes an elastic member 30 mounted on the carrier body 20. The elastic member 30 is normally in contact with the shaft body 10 or interferes with the shaft body 10. In this embodiment, the shaft body 10 has a base section 11 and at least one restriction section 12 formed on the base section 11. The restriction section 12 has the form of a plane face. The base section 11 has the form of an annular body. Therefore, the base section 11 has a radius larger than a distance between the restriction section 12 and an axis of the shaft body 10.

The carrier body 20 has an enclosure section 21 for enclosing the shaft body 10. The shaft body 10 is rotatable within the enclosure section 21. The carrier body 20 further has an extension section 22 for pivotally connecting with the movable module, whereby the carrier body 20 is movable along with the movement of the movable module as aforesaid.

In a preferred embodiment, the carrier body 20 has at least one main assembling section 24 and a subsidiary assembling section 25 for mounting the elastic member 30 on the carrier body 20. The main assembling section 24 and the subsidiary assembling section 25 respectively protrude from two ends of the extension section 22.

Referring to FIGS. 1, 2 and 3, the elastic member 30 has the form of a board body. The elastic member 30 has a first end 31, a second end 32 and a bridge section 33 connected between the first and second ends 31, 32. The bridge section 33 has an arched form. When the elastic member 30 (or the first end 31) interferes with the shaft body 10, the bridge section 33 permits the elastic member 30 to deform to a certain extent within a larger range.

In this embodiment, the first end 31 of the elastic member is formed with a main restraint section 34 in the form of a slot for receiving therein the main assembling section 24 of the carrier body 20. The main assembling section 24 is movable within the main restraint section 34. This will be further described hereinafter. The second end 32 of the elastic member is formed with a subsidiary restraint section 35 in the form of a notch corresponding to the subsidiary assembling section 25 of the carrier body 20. The subsidiary restraint section 35 is pivotally connected with or secured to the subsidiary assembling section 25 of the carrier body 20. When the shaft body 10 or the carrier body 20 is rotated, the elastic member 30 will be reciprocally moved and deformed with the subsidiary assembling section 25 and the subsidiary restraint section 35 as a fulcrum. Accordingly, the elastic member 30 can store energy or release energy.

In a preferred embodiment, the first end 31 of the elastic member is formed with an arched face 36 and two contact sections 37 formed on two sides of the arched face 36 corresponding to the base section 11 and the restriction section 12 of the shaft body 10. The contact sections 37 are in the form of plane face.

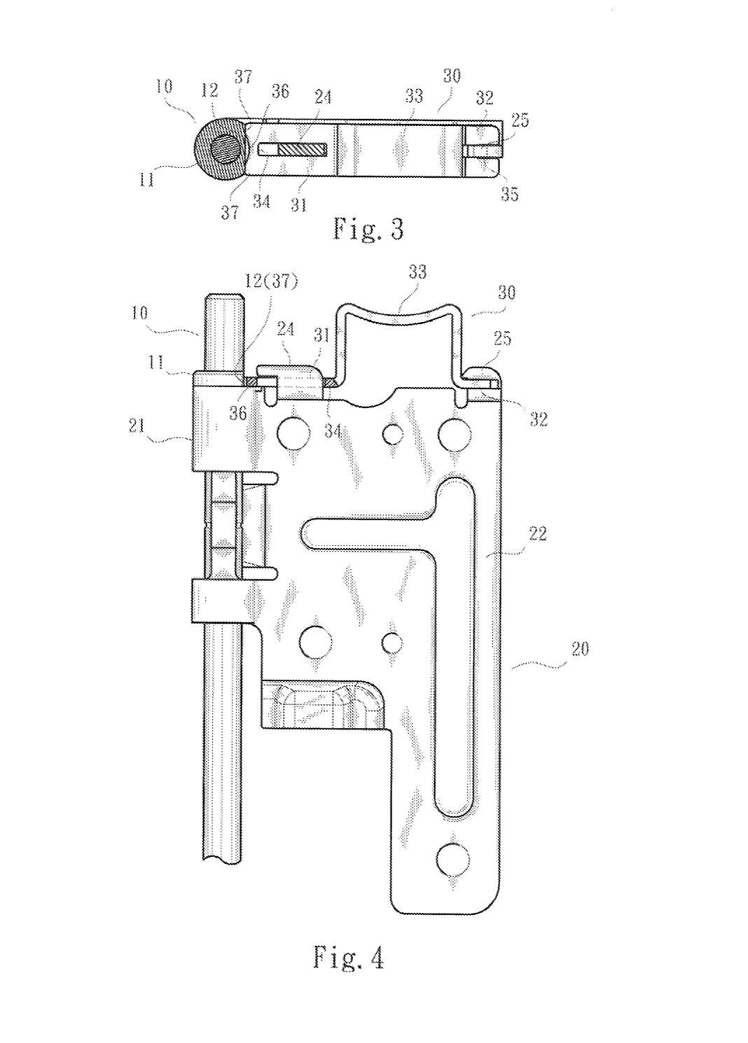

Referring to FIGS. 3 and 4, the contact sections 37 of the first end 31 of the elastic member serve to press the restriction section 12 of the shaft body in contact with the restriction section 12 or interfere with the restriction section 12 so as to stably and truly locate the shaft body.

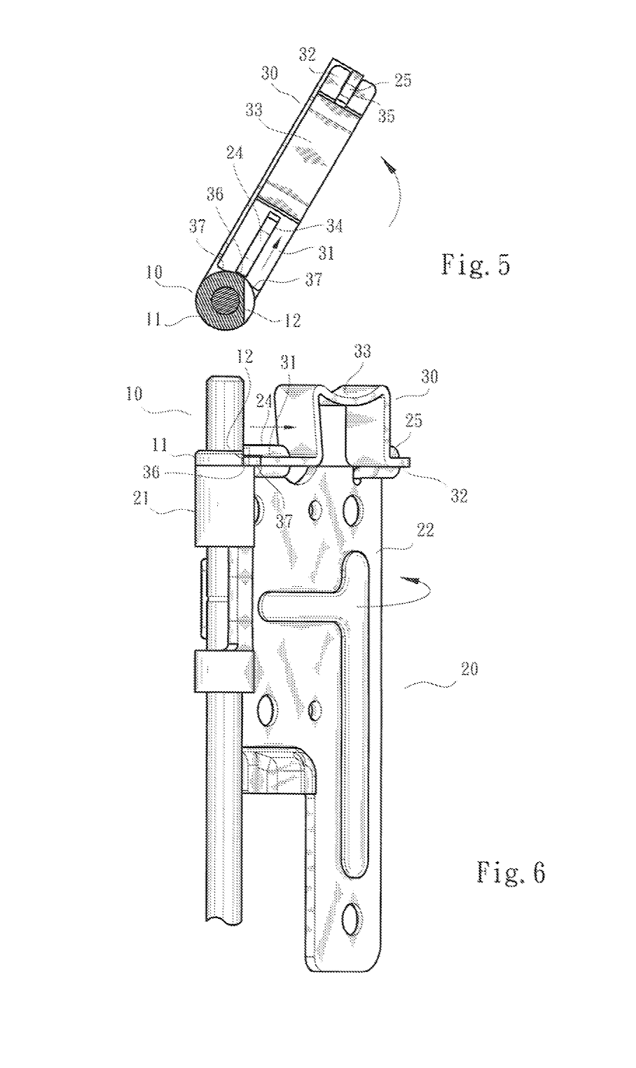

Please refer to FIGS. 3, 4, 5 and 6. In order to facilitate illustration, it is assumed that FIGS. 3 and 4 show that the movable module (or the carrier body 20) is positioned in a closed position where the movable module is closed onto the device body module, while FIGS. 5 and 6 show that the movable module (or the carrier body 20) is operated and moved to an opened position where the movable module is opened from the device body module.

When a user operates and rotates the movable module to make the carrier body 30 rotate from the position of FIG. 3 (or FIG. 4) to the position of FIG. 5 (or FIG. 6), the carrier body 20 drives the contact sections 37 of the first end 31 of the elastic member to leave the restriction section 12. As aforesaid, the radius of the base section 11 is larger than the distance between the restriction section 12 and the axis of the shaft body 10. Therefore, when the contact sections 37 of the first end 31 of the elastic member are driven by the carrier body 20 to contact or interfere with the base section 11, the elastic member 30 is pushed and pressed by the base section 11. At this time, the main restraint section 34 is moved to the right side of FIGS. 3 and 4 relative to the main assembling section 24 of the carrier body 20 to store energy. Moreover, after rotated, the carrier body 20 and the movable module are immediately located and prevented from shaking.

Please refer to FIGS. 5 and 6. When the user continuously operates and rotates the movable module and the carrier body 20, the arched face 36 of the first end 31 of the elastic member is rotated into contact with the base section 11 of the shaft body. At this time, the elastic member 30 releases the previously stored energy. In the meantime, the elastic member 30 is restored to its original state to abut against the shaft body 10. Under such circumstance, the elastic member 30 keeps in contact with the base section 11 to locate the shaft body in a state similar to that shown in FIGS. 3 and 4, (in which the contact sections 37 of the first end 31 of the elastic member contact the restriction section 12 of the shaft body). Accordingly, after rotated, the carrier body 20 and the movable module are immediately located.

According to the above arrangement, in comparison with the conventional device, the rotary shaft device of the present invention has the following advantages:

1. The relevant components of the rotary shaft device, (such as the shaft body 10 with the base section 11 and the restriction section 12, the elastic member 30 with the main restraint section 34 and the carrier body 20 with the main assembling section 24), are redesigned and different from those of the conventional device. For example, the first end 31 of the elastic member is formed with the arched face 36 and the contact sections 37. Also, the shaft body is formed with the base section 11 and the restriction section 12. In contrast, the conventional device employs multiple gaskets and frictional plates, which are troublesome and time-consuming to assemble. Also, the conventional device has a relatively complicated structure.

2. The arched bridge section 33 is connected between the first and second ends 31, 32 of the elastic member 30. Accordingly, the elastic member 30 can be elastically deformed to a larger extent. In contrast, in the conventional device, the gaskets are troublesomely tightened by means of wrenching the nut to adjust the frictional resistance. When tightened by the nut, the gaskets are stressed and likely to permanently deform and damage. In another type of conventional device, the relevant components are formed with insertion structures such as the locating protrusions/dents or recessed/raised locating sections. After a period of operation, the components are likely to wear. This will deteriorate the locating effect.

The above embodiments are only used to illustrate the present invention, not intended to limit the scope thereof. Many modifications of the above embodiments can be made without departing from the spirit of the present invention.

What is claimed is:

1. A rotary shaft device comprising a shaft body and an elastic member assembled with the shaft body, wherein:
the elastic member has a first end, a second end and a bridge section connected between the first and second ends;
the second end of the elastic member is pivotally connected with one of an electronic device and a carrier body; and
the first end of the elastic member normally interferes with the shaft body.

2. The rotary shaft device as claimed in claim 1, wherein the shaft body is assembled with the carrier body, the carrier body having an enclosure section and an extension section, the shaft body being enclosed in the enclosure section and rotatable within the enclosure section.

3. The rotary shaft device as claimed in claim 2, wherein the shaft body has the form of a cylindrical body and is mounted on the electronic device, the electronic device including a movable module and a device body module, the shaft body and the carrier body being respectively mounted on the device body module and the movable module, one of the carrier body and the shaft body being drivable by the electronic device.

4. The rotary shaft device as claimed in claim 3, wherein the extension section of the carrier body is pivotally connected with the movable module, whereby the carrier body is movable along with the movement of the movable module.

5. The rotary shaft device as claimed in claim 1, wherein the bridge section has an arched form.

6. The rotary shaft device as claimed in claim 2, wherein the elastic member is mounted on the carrier body.

7. The rotary shaft device as claimed in claim 1, wherein the shaft body has a base section and at least one restriction section formed on the base section.

8. The rotary shaft device as claimed in claim 7, wherein the restriction section of the shaft body has the form of a plane face.

9. The rotary shaft device as claimed in claim 7, wherein the base section of the shaft body has the form of an annular body.

10. The rotary shaft device as claimed in claim 7, wherein the base section has a radius larger than a distance between the restriction section and an axis of the shaft body.

11. The rotary shaft device as claimed in claim 2, wherein the carrier body has at least one main assembling section and the first end of the elastic member is formed with a main restraint section in which the assembling section of the carrier body is received.

12. The rotary shaft device as claimed in claim 2, wherein the carrier body has a subsidiary assembling section and the second end of the elastic member is formed with a subsidiary restraint section pivotally connected with the subsidiary assembling section of the carrier body.

13. The rotary shaft device as claimed in claim 11, wherein the main assembling section protrudes from the extension section.

14. The rotary shaft device as claimed in claim 12, wherein the subsidiary assembling section protrudes from the extension section.

15. The rotary shaft device as claimed in claim 1, wherein the elastic member has the form of a board body.

16. The rotary shaft device as claimed in claim 11, wherein the main restraint section is in the form of a slot for receiving the main assembling section, whereby the main assembling section is movable within the main restraint section.

17. The rotary shaft device as claimed in claim 12, wherein the subsidiary restraint section is in the form of a notch.

18. The rotary shaft device as claimed in claim 1, wherein the first end of the elastic member is formed with an arched face and two contact sections formed on two sides of the arched face.

19. The rotary shaft device as claimed in claim 18, wherein the contact sections are in the form of plane face.
